(19) United States
(12) Patent Application Publication
(10) Pub. No.: US 2011/0068051 A1
(43) Pub. Date: Mar. 24, 2011

(54) BALLISTIC SEPARATOR

(75) Inventors: Alain BRASSEUR, Ste-Catherine-de-Hatley (CA); Jean-François LECLERC, St-Denis-de-Brampton (CA)

(73) Assignee: 6358357 CANADA INC., Sherbrooke (CA)

(21) Appl. No.: 12/786,022

(22) Filed: May 24, 2010

Related U.S. Application Data
(60) Provisional application No. 61/180,663, filed on May 22, 2009.

(51) Int. Cl. B07B 4/02; B07B 11/02; B07B 11/06

(52) U.S. Cl. 209/137; 209/136; 209/147

(57) ABSTRACT

A system and method sorts bulk material containing lightweight components and heavier components, by separating the lightweight components from the heavier components. The method includes the steps of a) conveying the bulk material to be sorted, and releasing it through a corresponding outlet along a given trajectory; and b) generating an airflow and projecting said airflow adjacent to the outlet so that the airflow intersects the given trajectory of the bulk material, and draws along with it the lightweight material via a Venturi effect, thereby separating the lightweight components from the heavier components. This enables namely to easily, quickly and inexpensively sort out fairly lightweight materials, from heavier materials, at a substantial high throughput.

This application claims the benefit of Ser. No. 61/180,663, filed May 22, 2009 in the USA and which application is incorporated herein by reference. A claim of priority to all, to the extent appropriate is made.

### FIELD OF THE INVENTION

The present invention relates to a system and method for sorting bulk material. More particularly, the present invention relates to a system (hereinafter referred to also as a “ballistic separator”) and to a corresponding method for separating lightweight material from heavier material.

### BACKGROUND OF THE INVENTION

Systems and methods for sorting recycled material and the like are very well known in the art.

Also known in the art are picking systems for picking and sorting different types of materials from recovered bulk material. These systems are often used for recovering materials from recycling plants, construction waste, demolition debris and/or the like.

Known to the Applicant are the following US patents which describe various sorting systems: U.S. Pat. Nos. 4,452,694; 5,100,537; 5,353,937; 5,411,147; 5,448,363; 5,450,966; 5,471,311; 5,484,247; 5,485,925; 5,497,887; 5,499,488; 5,526,437; 5,529,169; 5,508,512; 5,509,537; 5,526,437; 5,562,214; 5,579,921; 5,586,663; 5,631,460; 5,675,416; 5,799,801; 5,862,919; 5,887,073; 5,960,964; 6,064,056; 6,137,074; 6,144,004; 6,149,018; 6,191,859 B1; 6,237,778 B1; 6,250,478 B1; 6,265,684 B1; 6,303,952 B1; 6,371,305 B1; 6,380,503 B1; 6,382,425 B1; 6,460,788 B1; 6,504,124 B1; 6,726,028 B2; and 6,787,724 B2.

Also known to the Applicant are the following foreign patents and/or patent applications which describe other sorting systems: CA 2,199,021; CA 2,224,918; DE 69721199.1; EP 0,849,006 B1; FR 2,735,996 A1; WO 94/20227 A1; WO 2007/112591 A1; WO 2007/112593 A1; and WO 2008/124946 A1.

However, none of these conventional systems and methods for sorting material are designed to easily, quickly and inexpensively sort out fairly lightweight materials (ex. paper, newspaper, plastic bags, etc.) from heavier materials (plastic bottles, glass, cardboard, and the like) at a substantial high throughput.

Hence, in light of the aforementioned, there is a need for an improved system which, by virtue of its design and components, would be able to overcome or at least minimize some of the aforementioned prior art concerns.

### SUMMARY OF THE INVENTION

The object of the present invention is to provide a system which satisfies some of the above-mentioned needs and which is thus an improvement over other related systems and/or sorting methods known in the prior art.

In accordance with the present invention, the above object is achieved, as will be easily understood, with a system (hereinafter referred to also as “ballistic separator”) such as the one briefly described herein and such as the one exemplified in the accompanying drawings.

More particularly, there is provided a system for sorting bulk material containing lightweight components and heavier components, by separating the lightweight components from the heavier components, the system comprising:

a main conveyor for conveying the bulk material to be sorted, and for releasing it through a corresponding outlet along a given trajectory; and an airflow generating assembly for generating an airflow, and for projecting said airflow adjacent to the outlet of the main conveyor so that the airflow intersects the given trajectory of the bulk material, and draws along with it the lightweight material via a Venturi effect, thereby separating the lightweight components from the heavier components.

Preferably, there is provided a system for sorting bulk material containing lightweight components and heavier components, by separating the lightweight components from the heavier components, the system comprising:
a main conveyor for conveying the bulk material to be sorted, and for releasing it through a corresponding outlet along a given free falling trajectory; and
an airflow generating assembly for generating an airflow, and for directing said airflow at an upward angle adjacent to the outlet of the main conveyor so that the airflow extending upwardly at an angle intersects the given free falling trajectory of the bulk material, and draws along with it the lightweight material via a Venturi effect, thereby separating the lightweight components from the heavier components.

According to another aspect of the present invention, there is provided a sorting assembly provided with the above-mentioned ballistic separator and/or components thereof.

According to another aspect of the present invention, there is provided a method of installing the above-mentioned ballistic separator and/or sorting assembly.

According to another aspect of the present invention, there is provided a method of operating the above-mentioned ballistic separator and/or sorting assembly.

According to another aspect of the present invention, there is provided a method of sorting bulk material by separating lightweight components from heavier components.

More particularly, there is provided a method of sorting bulk material containing lightweight components and heavier components, by separating the lightweight components from the heavier components, the method comprising the steps of:
a) conveying the bulk material to be sorted, and releasing it out through a corresponding outlet along a given trajectory; and
b) generating an airflow and projecting said airflow adjacent to the outlet so that the airflow intersects the given trajectory of the bulk material, and draws along with it the lightweight material via a Venturi effect, thereby separating the lightweight components from the heavier components.

Preferably, step a) comprises the step of releasing the bulk material to be sorted out through the outlet along a given free falling trajectory. Preferably also, step b) comprises the step of directing the airflow at an upward angle adjacent to the outlet.

According to another aspect of the present invention, there is provided material having been sorted with the above-mentioned ballistic separator and/or sorting assembly.

According to another aspect of the present invention, there is provided a kit with corresponding components for assembling the above-mentioned ballistic separator and/or sorting assembly.

Preferably, the kit comprises at least a main conveyor and an air generating assembly. The kit may further comprise at least one additional component taken from the group consisting of blower, air duct, nozzle, constricted section, first chute section, corresponding first auxiliary conveyor, second chute section and corresponding second auxiliary conveyor.

According to yet another aspect of the present invention, there is also provided a method of assembling components of the above-mentioned kit.

According to yet another aspect of the present invention, there is also provided a method of doing business with the above-mentioned kit, ballistic separator and/or sorting assembly.

The objects, advantages and other features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a schematic side view of a ballistic separator according to a preferred embodiment of the present invention.

FIG. 2 is a schematic side elevational view of a ballistic separator according to another preferred embodiment of the present invention.

FIG. 3 is a front view of a portion of what is shown in FIG. 2.

FIG. 4 is a top view of a portion of what is shown in FIG. 3.

FIG. 5 is a schematic side elevational view of an airflow generating assembly according to a given preferred embodiment of the present invention.

FIG. 6 is front view of what is shown in FIG. 5.

FIG. 7 is a top view of a portion of what is shown in FIG. 6.

FIG. 8 is a graph of velocity vectors (by velocity magnitude (m/s)) of an airflow generated with a ballistic separator according a given preferred embodiment of the present invention.

FIG. 9 is a graph of velocity vectors (by velocity magnitude (m/s)) of an airflow generated with a ballistic separator according another given preferred embodiment of the present invention.

### DETAILED DESCRIPTION OF PREFERRED EMBODIMENTS OF THE INVENTION

In the following description, the same numerical references refer to similar elements. The embodiments, geometrical configurations, materials mentioned and/or dimensions shown in the figures or described in the present description are preferred embodiments only, given for exemplification purposes only.

Moreover, although the present invention was primarily designed for substantially sorting out lightweight materials (example paper, newspaper, plastic bags, etc.) from heavier materials (such as bottles, whether plastic or glass, cardboards, and the like), it may be used with other types of objects, and in other fields, as apparent to a person skilled in the art. For this reason, expressions such as “sorting”, “material”, “paper”, “plastic bag”, etc., used herein should not be taken as to limit the scope of the present invention and includes all other kinds of objects or fields with which the present invention could be used and may be useful.

Moreover, in the context of the present invention, the expressions “system”, “separator”, “device”, “assembly”, “product”, “unit”, “invention” and any other equivalent expression and/or compound words thereof known in the art will be used interchangeably. Furthermore, the same applies for any other mutually equivalent expressions, such as “screening”, “sorting”, “separating”, “recycling” and “identifying”, for example, as well as “air and “fluid”, as well “flow” and “stream”, as apparent to a person skilled in the art.

In addition, although the preferred embodiment of the present invention as illustrated in the accompanying drawings may comprise various components, and although the preferred embodiment of the ballistic separator as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the ballistic separator and corresponding components according to the present invention, as will be briefly explained hereinafter and as can be easily inferred herefrom by a person skilled in the art, without departing from the scope of the invention.

### LIST OF NUMERICAL REFERENCES FOR SOME OF THE CORRESPONDING PREFERRED COMPONENTS ILLUSTRATED IN THE ACCOMPANYING DRAWINGS

1. system (or “ballistic separator”)
3. bulk material to be sorted
3a. lightweight components (of bulk material)
3b. heavier components (of bulk material)
5. main conveyor
7. outlet
9. trajectory
11. airflow generating assembly
13. airflow
15. angle
17. blower
19. air duct
21. nozzle
23. constricted section
25. at least one wall of variable profile
27. first chute section
29. first auxiliary conveyor
31. second chute section
33. second auxiliary conveyor
35. first end (of conveyor)
37. second end (of conveyor)
39. longitudinal axis (of conveyor)

Broadly described, the present invention, as illustrated in the accompanying drawings, relates to a ballistic separator (1) having components which cooperate with one another in order to sort out lighter materials (3a) from heavier materials (3b) using a Venturi suction effect (or any other appropriate aerodynamic effect) in order to draw the lighter materials (3a) up and away from the heavier materials (3b) into a corresponding section (or “chute”) (27) for either subsequent conveying in order to further process, and/or in order to further sort out for specific materials, if need may be.

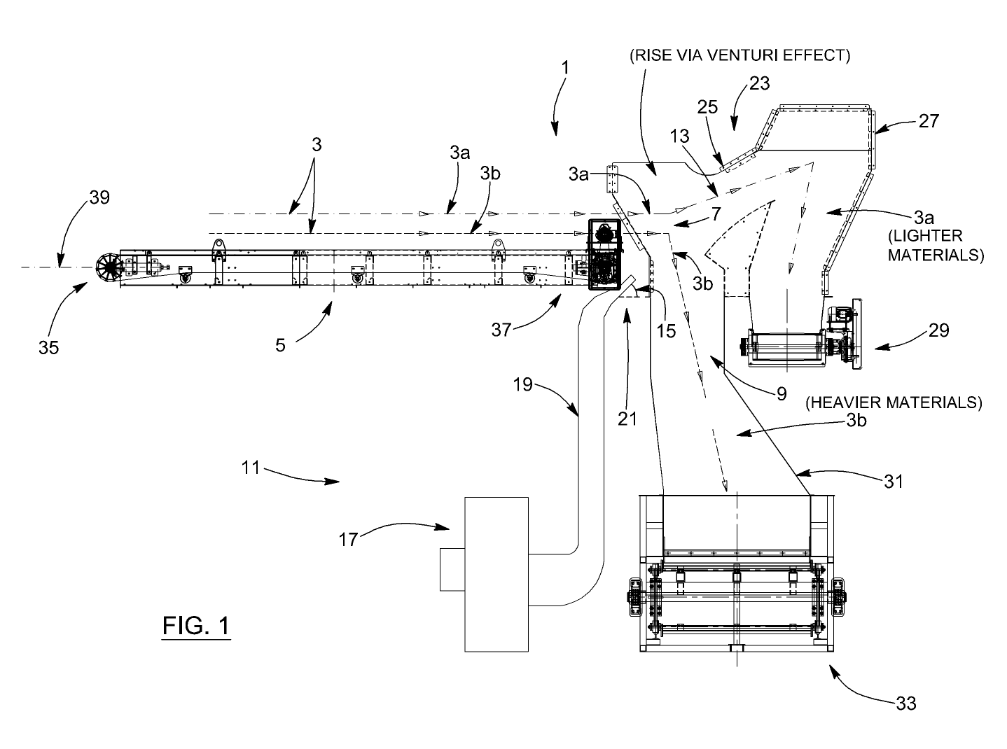

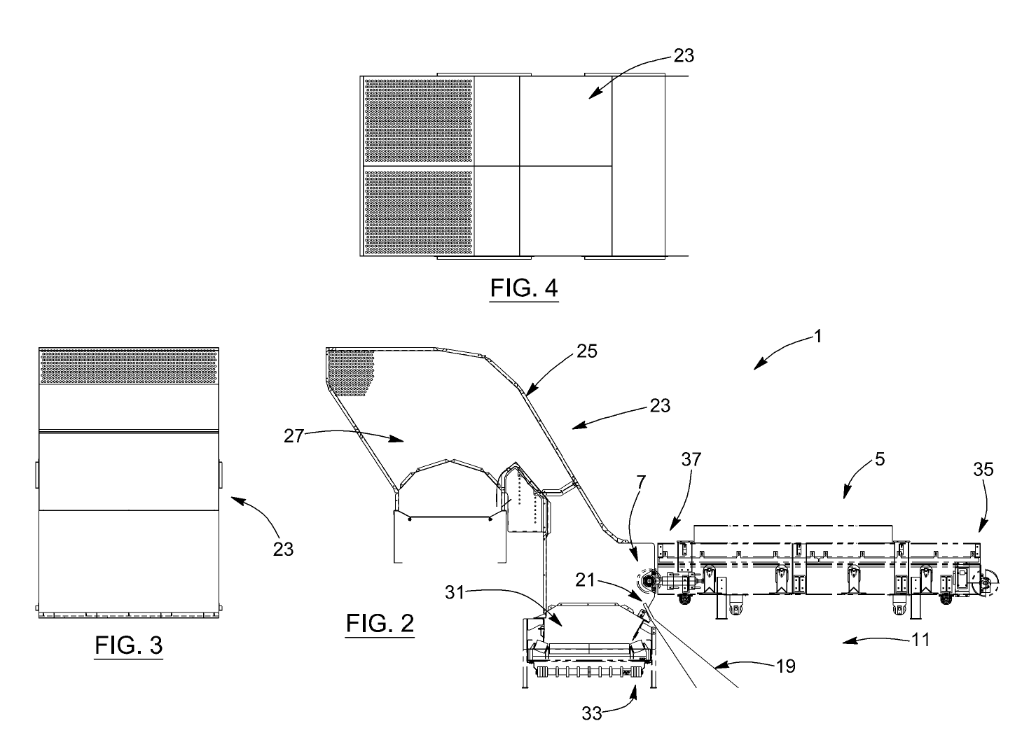

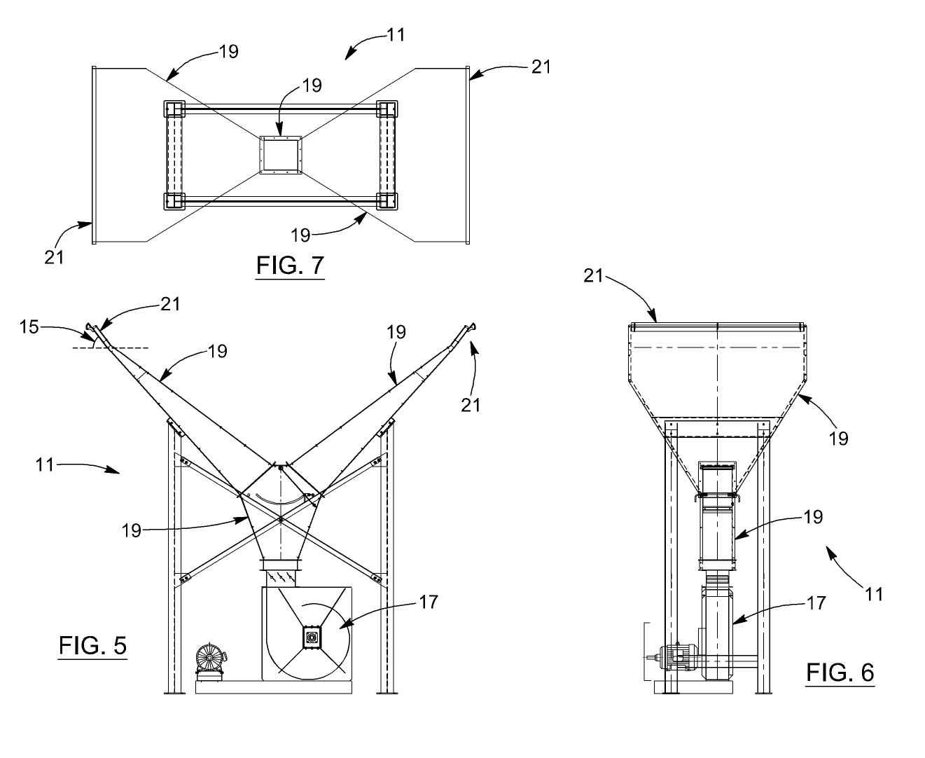

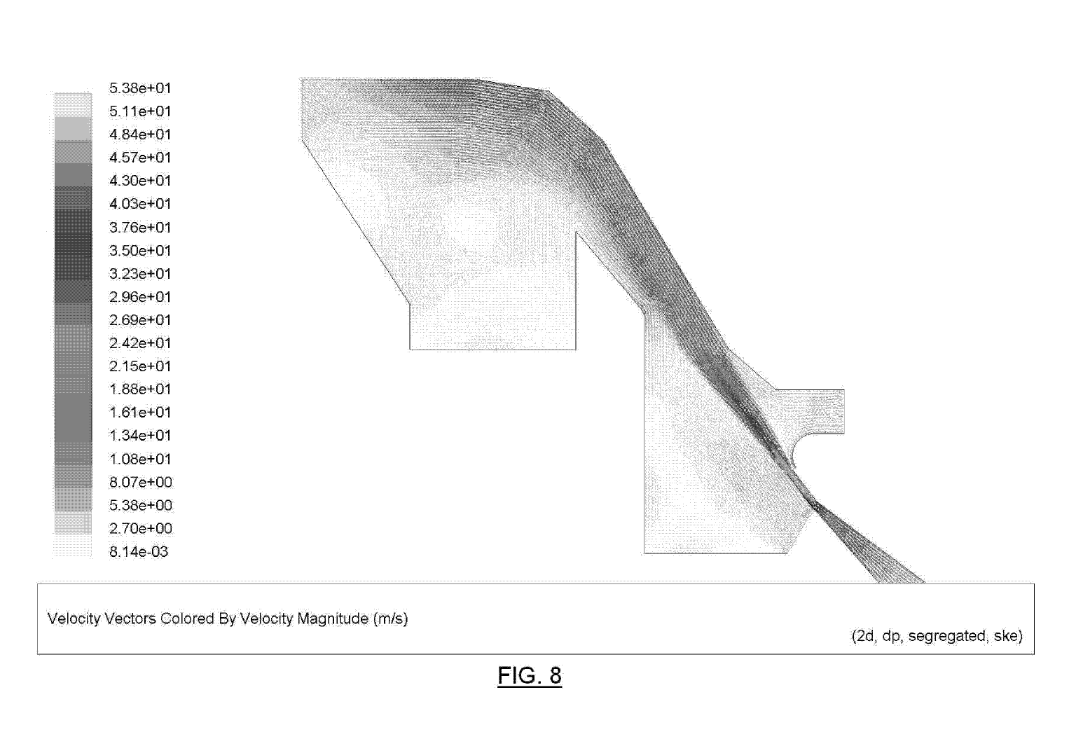

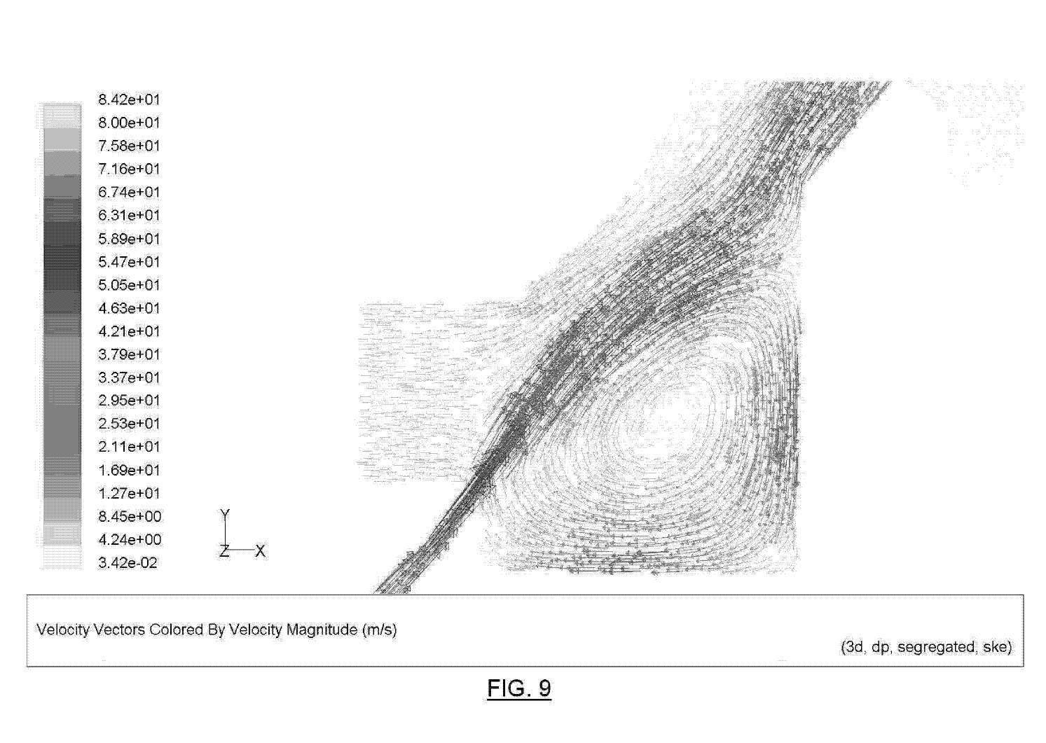

Indeed, as can be easily understood when referring to FIG. 1, bulk material (3) to be sorted out into lighter and heavier sorted materials (3a,3b) is generally conveyed onto a given portion of the ballistic separator (1) by means of a conveying assembly, which typically, can simply consist of a main conveyor (5) with a corresponding conveyor belt, as schematically illustrated in FIG. 1. The bulk material (3) is to be sorted out in such a way that, when exiting the conveyor belt, it is preferably exposed to the airflow (13) exiting from a corresponding nozzle (21) appropriately positioned adjacent to the end (37) of the conveyor (5) in order to intersect and/or have an effect on the output of the conveyor belt, so as to have in turn an effect on the lighter material (3a) and in turn induce it upwardly towards a corresponding receiving section (i.e. first chute section (27)) of the ballistic separator (1) for further processing, conveying and/or sorting. The airflow (13) exiting from the nozzle (21) which is appropriately positioned and oriented with respect to the end (37) of the conveyor is preferably provided by a suitable airflow generating assembly (11), such as a blower (17), as schematically illustrated in FIG. 1, and it is preferably relayed or conveyed from said blower (17) to the corresponding nozzle (21) via appropriate an air conducting assembly (air duct (19), tube, pipe, channel, etc.). The blower (17) is preferably configured for adjustably generating different airflows (i.e. of different power, velocity, etc.), and the nozzle (21) is preferably configured for being adjustable (in terms of positioning, angle, etc.) with respect to the outlet (7) of the main conveyor (5). As can be easily understood by person skilled in the art, the accelerated airflow (13) travels at a greater velocity than the relatively static velocity of ambient air, and thus, the surrounding atmospheric pressure is greater than that of the airflow's, thereby drawing (urging, sucking, etc.) the lightweight components (3a) of the bulk material (3) to be sorted along with the airflow (13), away from the heavier components (3b) which are simply allowed to continue to fall down into the second chute section (31).

As can also be easily understood also by a person skilled in the art when referring to the accompanying drawings and the present description, the receiving sections (27,31) of the corresponding ballistic separator, and preferably upper sections thereof, are preferably shaped and sized (in a tunnel-shaped configuration, etc.) so as to further increase the Venturi suction effect which would be caused by the airflow stream (13) exiting from the nozzle (21). Indeed, it can be easily understood that according to preferred embodiments of the present invention, corresponding sections of the ballistic separator (1) may be altered, whether open or closed, or changed in orientation and/or curvature, or any other suitable alteration of configurations can take place, so as to increase the Venturi effect, and allow the lighter material (3a) to be better sorted out from the heavier material (3b) in order to be drawn upwards (or elsewhere) into the receiving section (27) or chute of the lighter material (3a) to be sorted out. As can be also easily understood by a person skilled in the art when referring to the accompanying drawings, the heavier material (3b) which would not be drawn up via Venturi effect onto the upper receiving section (27) would simply fall down and is preferably intended to fall either into a corresponding chute (31) of heavier material (3b) having been sorted out, or onto a corresponding conveying assembly, such as a conveyor belt for example, for further conveying, processing and/or sorting out.

Indeed, according to a given preferred embodiment of the present invention, when referring to FIG. 1 for example, there is shown how the system (1) may comprise a constricted section (23) downstream of the nozzle (21) and along which the airflow (13) and corresponding lightweight components (3a) being drawn with it are intended to travel. The constricted section (23) may come in many different suitable shapes and forms, but could simply be defined by at least one wall (25) having a variable profile which may be selectively adjusted (in terms of positioning, curvature, etc.) so as to vary flow parameters of the airflow (13) traveling through the constricted section (23). Preferably, the system (1) comprises a first chute section (27) for receiving the lightweight components (3a) having been drawn with the airflow (13), and a corresponding first auxiliary conveyor (29) provided under the first chute section (27) for conveying the lightweight components (3a) being received, away from the first chute section (27), either for further conveying, processing and/or sorting out. Similarly, the system (1) may comprise a second chute section (31) for receiving the heavier components (3b) falling down out from the outlet (7) of the main conveyor (5), and a corresponding second auxiliary conveyor (33) provided under the second chute section (31) for conveying the heavier components (3b) being received, away from the second chute section (31), once again, for further conveying, processing, and/or sorting out, etc.

As better shown in FIG. 1, each conveyor (5,29,33) is preferably a substantially straight conveyor having opposite first and second ends (35,37), and extending along a respective longitudinal axis (39), but it is worth mentioning that other suitable conveying assemblies, as well as other suitable interfaces and/or outlets (7) for allowing a proper interaction between the bulk material (3) to be sorted and the airflow (13) intended to draw along with it the lightweight components (3a) via a Venturi effect (or any other appropriate aerodynamic effect, employing pressure differential, etc.) to be separated from the heavier components (3b), could be used according to the present invention, as apparent to a person skilled in the art.

Thus, as may now be better appreciated, the present ballistic separator (1) is preferably advantageous in that it provides for a very simple design which is inexpensive to assemble, operate, maintain and the like, and more particularly, with the added advantages that it allows to easily, quickly and inexpensively sort out fairly lightweight materials (3a), from heavier materials (3b), at a very substantial high throughput.

It is worth mentioning however that several modifications can be made to the present ballistic separator (1) without departing from the scope of the present invention, as can be easily understood by a person skilled in the art. Indeed, the different components of the ballistic separator (1) may be altered differently depending on the particular applications and/or the end results sought out, as can be easily understood by a person skilled in the art. For example, the angle of the airflow and other flow parameters may be adjustable.

Of course, numerous modifications could be made to the above-described embodiments without departing from the scope of the invention, as defined in the appended claims.

1. A system for sorting bulk material containing lightweight components and heavier components, by separating the lightweight components from the heavier components, the system comprising:
a main conveyor for conveying the bulk material to be sorted, and for releasing it through a corresponding outlet along a given free falling trajectory;
and an airflow generating assembly for generating an airflow, and for directing said airflow at an upward angle adjacent to the outlet of the main conveyor so that the airflow extending upwardly at an angle intersects the given free falling trajectory of the bulk material, and draws along with it the lightweight material via a Venturi effect, thereby separating the lightweight components from the heavier components.

2. A system according to claim 1, wherein the angle of the airflow and other flow parameters are adjustable.

3. A system according to claim 2, wherein the airflow generating assembly comprises a blower for generating the airflow.

4. A system according to claim 3, wherein the blower is configured for adjustably generating different airflows.

5. A system according to claim 4, wherein the airflow generating assembly comprises an air duct for conveying the airflow.

6. A system according to claim 5, wherein the airflow generating assembly comprises a nozzle for releasing the airflow.

7. A system according to claim 6, wherein the nozzle is configured for being adjustable with respect to the outlet of the main conveyor.

8. A system according to claim 7, wherein the system comprises a constricted section downstream of the nozzle and along which the airflow and corresponding lightweight components being drawn with the airflow are intended to travel.

9. A system according to claim 8, wherein the constricted section is defined by at least one wall having a variable profile which may be selectively adjusted so as to vary flow parameters of the airflow traveling through the constricted section.

10. A system according to claim 9, wherein the system comprises a first chute section for receiving the lightweight components having been drawn with the airflow.

11. A system according to claim 10, wherein the system comprises a first auxiliary conveyor provided under the first chute section for conveying the lightweight components being received, away from the first chute section.

12. A system according to claim 11, wherein the system comprises a second chute section for receiving the heavier components falling from the outlet of the main conveyor.

13. A system according to claim 12, wherein the system comprises a second auxiliary conveyor provided under the second chute section for conveying the heavier components being received, away from the second chute section.

14. A system according to claim 13, wherein each conveyor is a substantially straight conveyor having opposite first and second ends, and extending along a respective longitudinal axis.

15. A system for sorting bulk material containing lightweight components and heavier components, by separating the lightweight components from the heavier components, the system comprising:
a main conveyor for conveying the bulk material to be sorted, and for releasing the bulk material through a corresponding outlet along a given trajectory; and
an airflow generating assembly for generating an airflow, and for projecting said airflow adjacent to the outlet of the main conveyor so that the airflow intersects the given trajectory of the bulk material, and draws along with the airflow the lightweight material via a Venturi effect, thereby separating the lightweight components from the heavier components.

16. A kit comprising a main conveyor and an air generating assembly to be connected onto one another for assembling the system of claim 15.

17. A kit according to claim 16, wherein the kit further comprises at least one additional component taken from the group consisting of blower, air duct, nozzle, constricted section, first chute section, corresponding first auxiliary conveyor, second chute section and corresponding second auxiliary conveyor.

18. A method of sorting bulk material containing lightweight components and heavier components, by separating the lightweight components from the heavier components, the method comprising the steps of:
a) conveying the bulk material to be sorted, and releasing the bulk material out through a corresponding outlet along a given trajectory; and
b) generating an airflow and projecting said airflow adjacent to the outlet so that the airflow intersects the given trajectory of the bulk material, and draws along with the airflow the lightweight material via a Venturi effect, thereby separating the lightweight components from the heavier components.

19. A method according to claim 18, wherein step a) comprises the step of releasing the bulk material to be sorted out through the outlet along a given free falling trajectory.

20. A method according to claim 19, wherein step b) comprises the step of directing the airflow at an upward angle adjacent to the outlet.
